(19) United States
(12) Patent Application Publication
(10) Pub. No.: US 2014/0115618 A1
(43) Pub. Date: Apr. 24, 2014

(54) VIDEO PROCESSING SYSTEM, ADVERTISEMENT ACQUISITION METHOD, VIDEO PROCESSING DEVICE, AND METHOD FOR CONTROLLING SAME

(71) Applicant: NEC Corporation, Tokyo (JP)

(72) Inventors: Hiroo Harada, Tokyo (JP); Naotake Fujita, Tokyo (JP)

(73) Assignee: NEC Corporation, Tokyo (JP)

(21) Appl. No.: 14/126,818

(22) PCT Filed: Jun. 20, 2012
(86) PCT No.: PCT/JP2012/066313

§ 371 Date: Dec. 16, 2013

(30) Foreign Application Priority Data
Jun. 23, 2011 (JP) 2011-139338

(51) Int. Cl. H04N 21/24; H04N 21/81

(52) U.S. Cl. CPC H04N 21/2407; H04N 21/812
USPC 725/19

(57) ABSTRACT

A variety of advertisement information is associated with a scene being played back and the advertisement information is provided.

An advertisement information database, which can search for advertisement information corresponding to a frame feature quantity, associates a frame included in a video with a characteristic frame feature quantity, and stores the advertisement information. A frame feature quantity extraction unit extracts a frame feature quantity from a frame of a video being played back. An advertisement information acquisition unit acquires, from the advertisement information database, advertisement information corresponding to the frame feature quantity extracted by the frame feature quantity extraction unit.

### FIELD OF THE INVENTION

The present invention relates to a technology of acquiring advertisements corresponding to video being played back.

### BACKGROUND OF THE INVENTION

In the patent literature 1, a technology which associates a feature quantity of content including moving pictures with a meta-data of a caption or an audio guidance and registers them in advance, searches the caption or the audio guidance based on the feature quantity extracted from the content which is played back, and plays back the caption and the audio guidance synchronously is disclosed. And, in the patent literature 2, technology which extracts a frame feature quantity which characterizes a frame picture by a little quantity of information from each frame of video contents is disclosed.

[Patent Literature 1] Japanese Patent Application Laid-Open No. 2008-166914

[Patent Literature 2] International publication 2010/084714 A1

### SUMMARY OF THE INVENTION

### Problems to be Solved by the Invention

In the technology described in the above-mentioned patent literature 1, it associates the meta-data of the caption or the audio guidance with every content, however; there is a problem that it cannot process information associated with a feature quantity of a frame which configures a part of the content.

And, in the technology described in the above-mentioned patent literature 2, in case of transmitting an advertisement corresponding to a video being played back, there is a problem that it cannot provide a variety of advertisement associated with a scene being played back.

The object of the present invention is to provide a video processing system, an advertisement acquisition method, a video processing device and a method for controlling same for solving the above-mentioned problems.

### Means for Solving the Problem

To achieve the above-mentioned object, a video processing system according to the present invention, includes: an advertisement information database which stores advertisement information associated with a frame feature quantity which characterizes a frame included in a video, and enabling to search the advertisement information which is corresponding to the frame feature quantity; frame feature quantity extraction unit which extracts the frame feature quantity from a frame of video being played back; and advertisement information acquisition unit which acquires the advertisement information corresponding to the frame feature quantity which is extracted by said frame feature quantity extraction unit from said advertisement information database.

To achieve the above-mentioned object, an advertisement acquisition method according to the present invention, includes: extracting a frame feature quantity from a frame of a video being played back; storing advertisement information associated with the frame feature quantity which characterizes the frame included in the video corresponding to the frame feature quantity which is extracted; and acquiring the advertisement information from an advertisement information database which can search the advertisement information corresponding to the frame feature quantity.

To achieve the above-mentioned object, a video processing device according to the present invention, includes: an advertisement information database for storing advertisement information associated with a frame feature quantity which characterizes a frame included in a video and enabling to search the advertisement information which is corresponding to the frame feature quantity; frame feature quantity reception means for receiving the frame feature quantity extracted from the frame of the video being played back; and advertisement information acquisition means for acquiring the advertisement information from said advertisement information database corresponding to the frame feature quantity which is received by said frame feature quantity means.

To achieve the above-mentioned object, a method of controlling a video processing device according to the present invention, includes: receiving a frame feature quantity extracted from a frame of a video being played back; storing advertisement information associated with the frame feature quantity which characterizes the frame included in the video corresponding to the received frame feature quantity; and acquiring the advertisement information from an advertisement information database which can search the advertisement information corresponding to the frame feature quantity.

To achieve the above-mentioned object, a program according to the present invention causes a computer to execute: a frame feature quantity reception process for receiving a frame feature quantity extracted from a frame of a video being played back; and an advertisement information transmission process for storing advertisement information associated with the frame feature quantity which characterizes the frame included in the video corresponding to the frame feature quantity which is received in the frame feature quantity reception process, and acquiring the advertisement information from an advertisement information database which can search the advertisement information corresponding to the frame feature quantity.

### Effect of the Invention

According to the present invention, it can provide a variety of advertisement associated with a scene being played back.

### BRIEF DESCRIPTION OF THE DRAWINGS

FIG. 1 is a block diagram showing an example of a configuration of a video processing system according to a first exemplary embodiment of the present invention.

FIG. 2 is a block diagram showing an example of a configuration of a video processing system according to a second exemplary embodiment of the present invention.

FIG. 3 is a sequence diagram showing an example of operation process of the video processing system according to the second exemplary embodiment of the present invention.

FIG. 4A is a block diagram showing an example of a configuration of a frame feature quantity extraction unit according to the second exemplary embodiment of the present invention.

FIG. 4B is a diagram showing processes of the frame feature quantity extraction unit according to the second exemplary embodiment of the present invention.

FIG. 4C is a diagram showing extraction areas of the frame feature quantity extraction unit according to the second exemplary embodiment of the present invention.

FIG. 5 is a block diagram showing an example of a hardware configuration of a video processing device according to the second exemplary embodiment of the present invention.

FIG. 6 is a diagram showing an example of a configuration of an advertisement information database according to the second exemplary embodiment of the present invention.

FIG. 7 is a flowchart showing an example of process procedure of the video processing device according to the second exemplary embodiment of the present invention.

FIG. 8 is a sequence diagram showing an example of operation process of a video processing system according to a third exemplary embodiment of the present invention.

FIG. 9 is a sequence diagram showing an example of operation process of a video processing system according to a fourth exemplary embodiment of the present invention.

FIG. 10 is a diagram showing an example of a configuration of an advertisement information database according to the fourth exemplary embodiment of the present invention.

FIG. 11 is a diagram showing an example of a configuration of an advertisement information database according to a fifth exemplary embodiment of the present invention.

### EXEMAPLARY EMBODIMENT OF THE INVENTION

Hereinafter, exemplary embodiments of the present invention will be described exemplarily and in detail with reference to the figures. However, components described in the following exemplary embodiments are illustrative for example, and it is not an intention to limit the technological scopes of the present invention to those.

### First Exemplary Embodiment

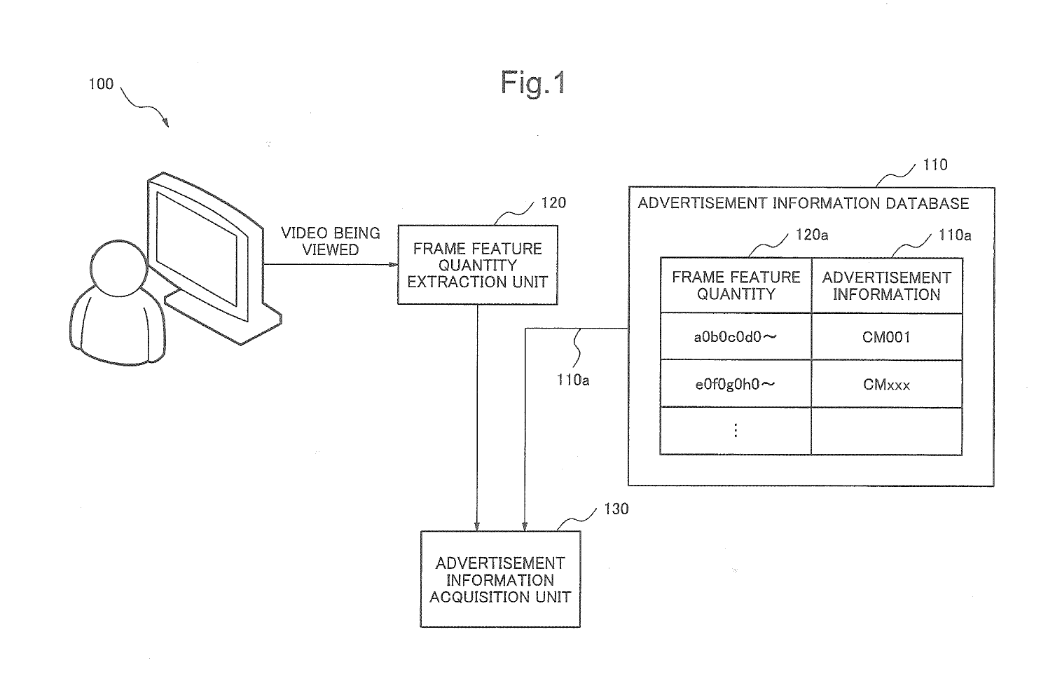

A video processing system 100 according to the first exemplary embodiment of the present invention will be described with reference to FIG. 1.

As shown in FIG. 1, the video processing system 100 includes an advertisement information database 110, a frame feature quantity extraction unit 120 and an advertisement information acquisition unit 130.

The advertisement information database 110 stores advertisement information 110a associated with a frame feature quantity 120a which characterizes a frame included in a video. And, the advertisement information database 110 can search the advertisement information 110a which is corresponding to the frame feature quantity 120a.

The frame feature quantity extraction unit 120 receives the frame of video being played back and extracts (searches) the frame feature quantity 120a from the frame.

The advertisement information acquisition unit 130 acquires the advertisement information 110a from the advertisement information database 110 in accordance with the frame feature quantity 120a which is extracted by the frame feature quantity extraction unit 120.

The video processing system 100 according to this exemplary embodiment can associate a variety of advertisements with scenes being played back and provide them.

The reason is because, in the video processing system 100, the frame feature quantity extraction unit 120 extracts the frame feature quantity 120a from the frame of the video being played back, and the advertisement information acquisition unit 130 acquires the advertisement information 110a from the advertisement information database 110 in accordance with the extracted frame feature quantity 120a.

### Second Exemplary Embodiment

Next, a video processing system 200 according to the second exemplary embodiment of the present invention will be described. A video processing device 210 according to the exemplary embodiment transmits the advertisement information registered previously in advertisement information database 213 (it is corresponds to the advertisement information database 110 in FIG. 1. Hereinafter, it is said the advertisement information DB 213) in real-time during playback of video contents at video viewing terminal 230, 240 or 250. The video processing system 200 according to the exemplary embodiment can transmit desired advertisement information during playback of video contents. Further, the video processing system 200 according to the exemplary embodiment sets transmission conditions for transmission of the advertisement, and searches the advertisement information considering the transmission conditions. The video processing system 200 according to the exemplary embodiment can manage the transmission of the advertisement information based on the transmission conditions.

<<Configuration of Video Processing System>>

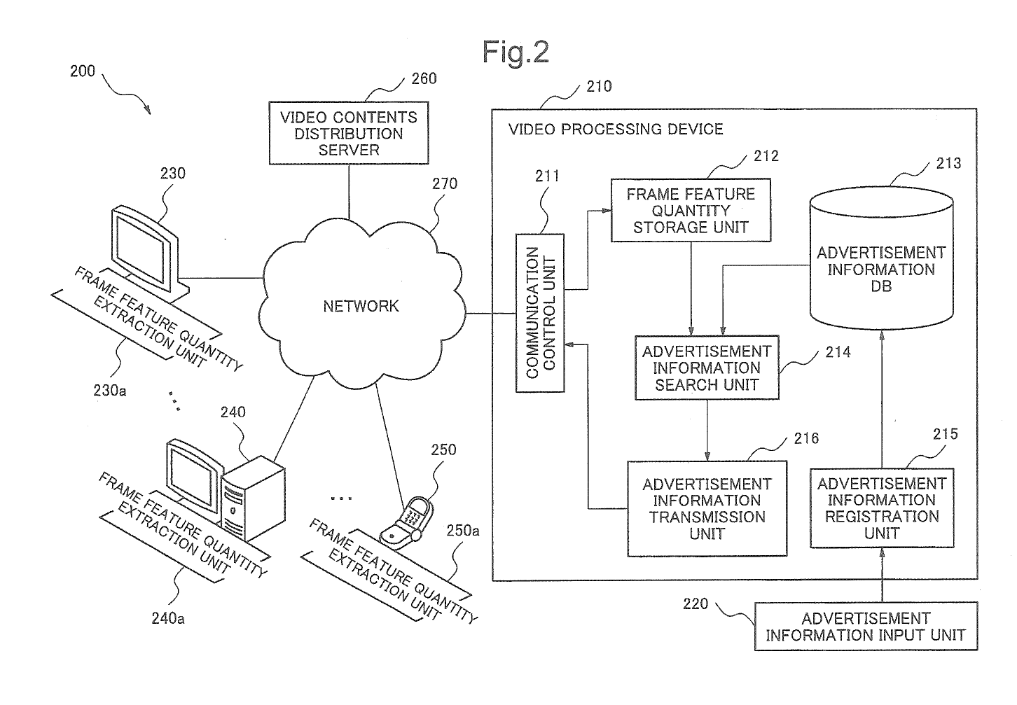

FIG. 2 is the block diagram showing a configuration of the video processing system 200 according to this exemplary embodiment.

In FIG. 2, the video processing system 200 includes the video processing device 210, an advertisement information input unit 220, the video viewing terminal 230, the video viewing terminal 240, the video viewing terminal 250, a video contents distribution server 260 and a network 270.

The video processing device 210 includes a communication control unit 211, a frame feature quantity storage unit 212, the advertisement information DB 213, an advertisement information search unit 214, an advertisement information registration unit 215 and an advertisement information transmission unit 216.

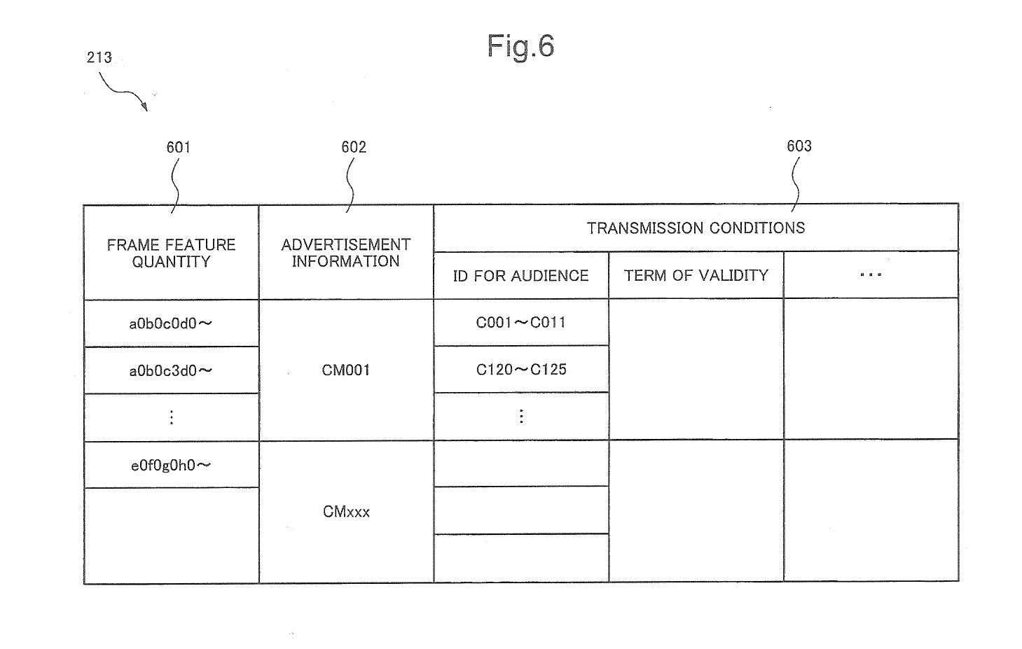

The advertisement information DB 213 corresponds to the advertisement information database 110 in FIG. 1, and stores the frame feature quantity which characterizes each frame of the video content and the advertisement information which is associated with the frame feature quantity for comparison. In the exemplary embodiment, there are especially no limitations on form of information which the advertisement information DB 213 stores. However, in the following description, the advertisement information DB 213 will be described such that it is supposed that the advertisement information DB 213 shown in FIG. 6 is used (refer to FIG. 6). In addition, comparison of the frame feature quantity according to the exemplary embodiment is not limited to be judgment of full match. For example, the comparison of the frame feature quantity according to the exemplary embodiment may be the judgment of a partial match, or of based on whether or not it resembles as a whole based on comparison between a distance and a threshold value. Accordingly, in the exemplary embodiment, it can also assume that a derivation scene which is processed and acquired from a scene composed of series of frames may be used for match.

The communication control unit 211 communicates with the video contents distribution server 260 and the video viewing terminal 230, 240 or 250 via the network 270. In addition, communication of the communication control unit 211 may be wired communication or wireless communication and is not limited especially. Then, the communication control unit 211 also functions as “frame feature quantity reception unit” which receives the frame feature quantity from the video viewing terminal 230, 240 or 250.

The frame feature quantity storage unit 212 stores a series of frame feature quantities of the video content which the communication control unit 211 received.

The advertisement information search unit 214 compares the frame feature quantity which the frame feature quantity storage unit 212 stores, with the frame feature quantity in the advertisement information DB 213, searches advertisement information which is associated with the matched frame feature quantity, and outputs it to the advertisement information transmission unit 216. The advertisement information search unit 214 corresponds to the advertisement information acquisition unit 130 in FIG. 1.

The advertisement information registration unit 215 registers a frame feature quantity, advertisement information, transmission conditions and so on which are inputted from the advertisement information input unit 220 in the advertisement information DB 213.

The advertisement information transmission unit 216 transmits the advertisement information which the advertisement information search unit 214 searched to the video viewing terminals 230-250 which are connected with the network 270 via the communication control unit 211.

The advertisement information input unit 220 receives information which is necessary for the video processing system 200 from other device which is not shown, and transmits it to the video processing device 210. Or, it receives necessary information based on input operations of a predetermined worker by using input device such as a keyboard or a mouse, and transmits it to the video processing device 210. In addition, the advertisement information input unit 220 may be included in the video processing device 210.

In addition, the exemplary embodiment may have the following configurations. The video processing device 210 provides a scene to the advertisement information input unit 220. The advertisement information input unit 220 associates the received advertisement information with a frame feature quantity of the received scene, and sends back it to the video processing device 210. The video processing device 210 registers the received frame feature quantity and the advertisement information in the advertisement information DB 213. Because the video processing device 210 does not need to manage the frame feature quantity, this configuration can simplify registration of the advertisement information.

The video viewing terminals 230-250 in FIG. 2 are video playback devices, and play back video contents downloaded via the network 270. In addition, the video viewing terminals 230-250 may play back video contents in a storage medium such as DVDs (Digital Versatile Disc). The video viewing terminal 230, the video viewing terminal 240 and the video viewing terminal 250 according to the exemplary embodiment respectively have a frame feature quantity extraction unit 230a, a frame feature quantity extraction unit 240a and a frame feature quantity extraction unit 250a which extract the frame feature quantity of each frame from a video being played back. The frame feature quantity extraction unit 230a-250a correspond to the frame feature quantity extraction unit 120 in FIG. 1.

The video contents distribution server 260 distributes video contents to the video viewing terminals 230-250.

The network 270 is a communication network which connects devices included in the video processing system 200.

<<Operation Process of Video Processing System>>

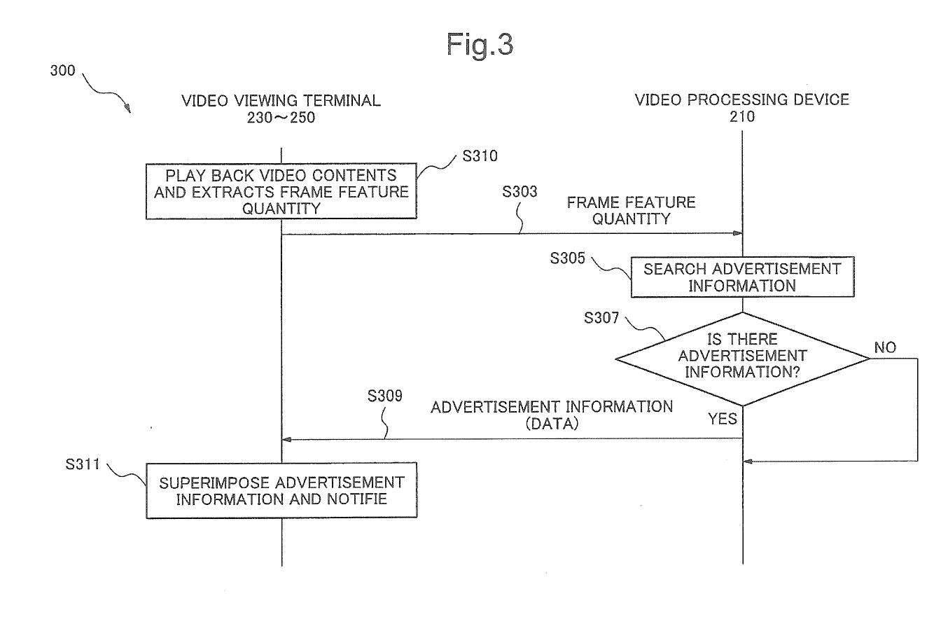

FIG. 3 is the sequence diagram showing operation process 300 of the video processing system 200 according to this exemplary embodiment. In addition, details such as initialization of each device are omitted.

First, one of the video viewing terminals 230-250 starts playback of a video content. When the playback starts, the frame feature quantity extraction unit 230a-250a of the video viewing terminal 230-250 extracts a frame feature quantity of a playback frame of the video content (S310).

The video viewing terminal 230-250 transmits the extracted frame feature quantity to the video processing device 210 via the network 270 (S303).

The video processing device 210 received the frame feature quantity compares the received frame feature quantity with the frame feature quantities in the advertisement information DB 213, and searches whether or not there is advertisement information which is transmitted (S305).

The video processing device 210 judges that there is advertisement information if there is a matched frame feature quantity (S307).

When the video processing device 210 judged that there is the advertisement information (YES in S307), it transmits the advertisement information which is registered by associated with the matched frame feature quantity to video viewing terminal 230-250 which is a transmission source of the corresponded frame feature quantity (S309).

In addition, the video processing device 210 may judge a match of the transmission conditions in addition to the match of the frame feature quantity in the search of the advertisement information.

When the video processing device 210 judges that there is no advertisement information (NO in S307), it does not process in particular, and finishes the operation.

The video viewing terminal 230, 240 or 250 which is the transmission source of the frame feature quantity and received the advertisement information superimposes the advertisement information and notifies it (S311). For example, when the advertisement information is a character, the video viewing terminal 230-250 superimposes the character of the advertisement information on a playback screen. When the advertisement information is sound, video or image, the video viewing terminal 230-250 superimposes and plays back the advertisement information with a method not to disturb the viewing of audience. Or, the video viewing terminal 230-250 plays back the advertisement video after a designated scene finishes. And, the video viewing terminal 230-250 may replace and play back the advertisement video instead of the designated specific scene.

<<Configuration and Process of Frame Feature Quantity Extraction Unit>>

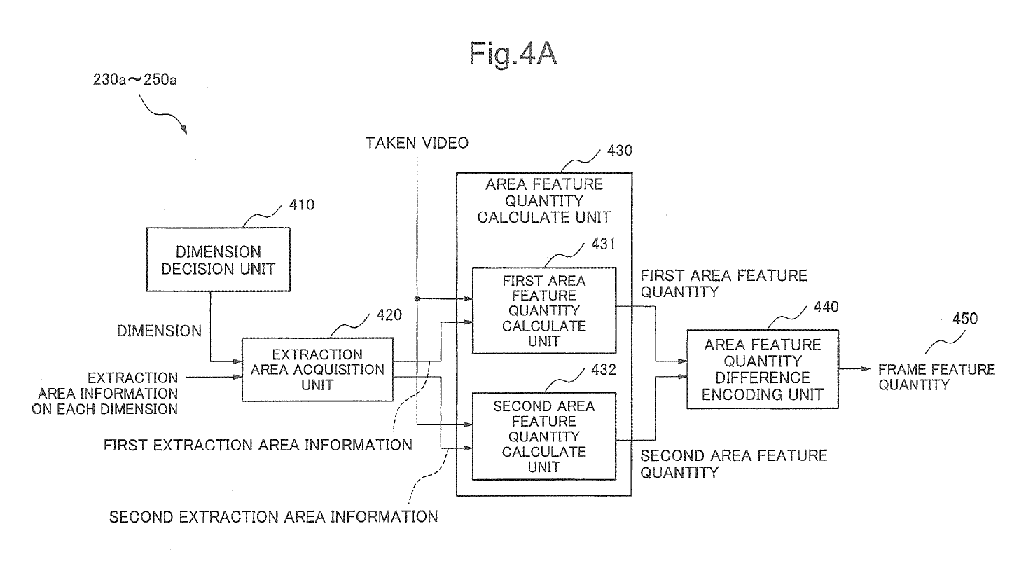

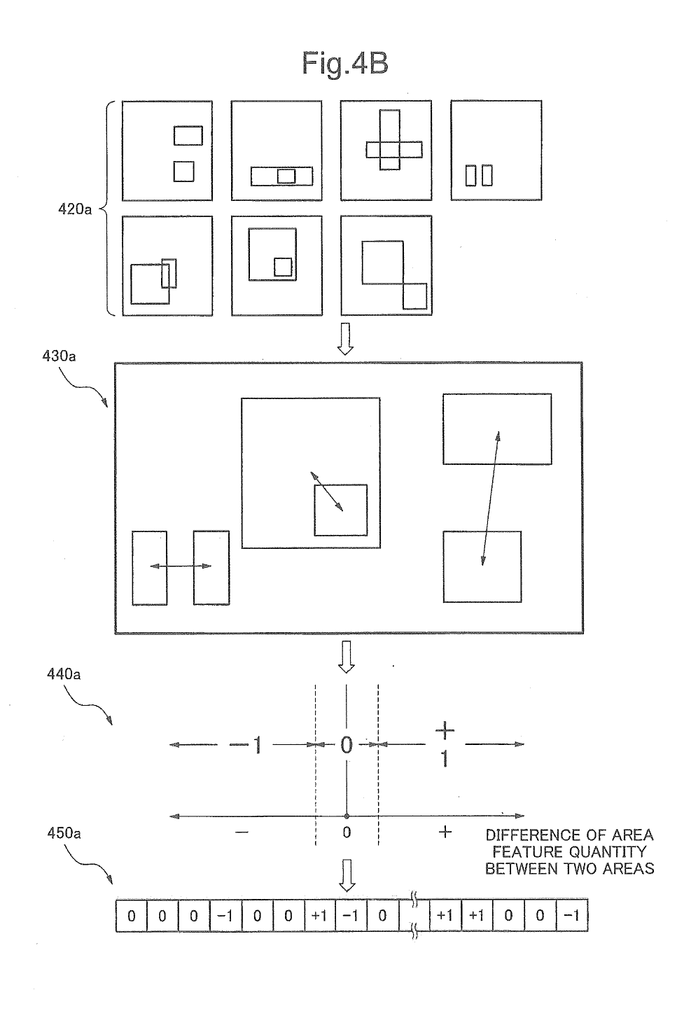

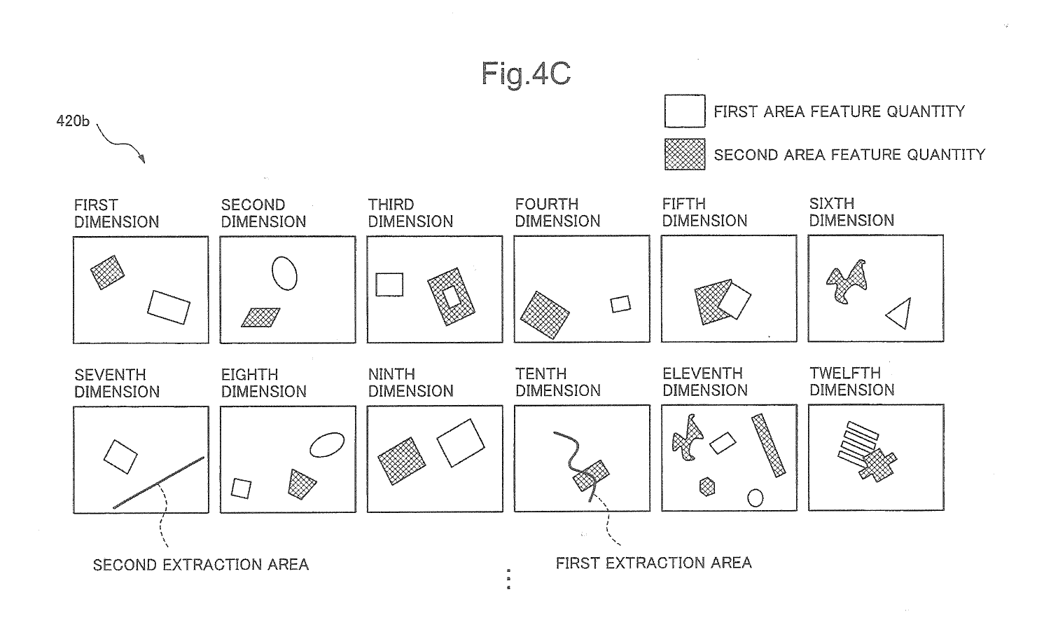

FIG. 4A is the block diagram showing an example of a configuration of the frame feature quantity extraction unit 230a-250a according to the exemplary embodiment. The frame feature quantity extraction unit 230a-250a applied in the exemplary embodiment, for example, are functional configuration units which extract a video signature adopted to standardization of MPEG7 (Moving Picture Experts Group).

The frame feature quantity extraction unit 230a-250a include a dimension decision unit 410, an extraction area acquisition unit 420, an area feature quantity calculation unit 430 and an area feature quantity difference encoding unit 440.

In the exemplary embodiment, a frame feature quantity 450 is not limited especially. The frame feature quantity 450 which is output shown as one example in FIG. 4A is produced by setting plural pairs of areas which have different sizes and shapes in each frame picture of the taken video, quantizing (for example, into three values) difference of an average luminance value which is a kind of area feature quantity among these areas, and encoding it.

The dimension decision unit 410 determines a number (dimension) of pairs of areas, and notifies it to the extraction area acquisition unit 420. Here, the one dimension corresponds to one pair of areas.

The extraction area acquisition unit 420 acquires a pair of areas of each dimension for calculating the frame feature quantity based on the dimension determined by the dimension decision unit 410 and dimension extraction area information acquired in advance. Then, the extraction area acquisition unit 420 transmits information of the pair of extraction areas which make pairs (extraction area information) to the area feature quantity calculation unit 430.

The area feature quantity calculation unit 430 includes the first area feature quantity calculation unit 431 and the second area feature quantity calculation unit 432. The first area feature quantity calculation unit 431 and the second area feature quantity calculation unit 432 respectively calculate the area feature quantity (in this case, the average luminance as a kind of it) of one area of the pair of areas of each dimension based on the extraction area information. The area feature quantity calculation unit 430 transmits the area feature quantity to the area feature quantity difference encoding unit 440.

The area feature quantity difference encoding unit 440 calculates a difference of the area feature quantities (in this case, average luminance) of each pair of areas, quantizes and encodes the difference (in this case, three values) according to a threshold value, and outputs it as the frame feature quantity 450.

In addition, in the following description according to the exemplary embodiment, it described such that the average luminance is as a representative of the area feature quantity. However, the area feature quantity according to the exemplary embodiment is not limited to the average luminance of an area. The area feature quantity, for example, can be applied other processes of the luminance or the feature quantity of the frame other than the luminance.

FIG. 4B is the diagram showing the processes in the frame feature quantity extraction unit 230a-250a according to the exemplary embodiment.

420a in FIG. 4B indicates an example of a pair of areas which the extraction area acquisition unit 420 in FIG. 4A acquires. In the 420a, the outside frame indicates a frame, and each inner rectangle indicates an area which becomes the pair.

The 430a in FIG. 4B indicates a pair of areas which the extraction area acquisition unit 420 extracted in the frame picture and a relationship in which a difference between these areas is taken. The extraction area acquisition unit 420 extracts a pair of areas in the frame picture. Then, the area feature quantity calculation unit 430 calculates the area feature quantity (here, average luminance of pixels) included in each area. Then, the area feature quantity difference encoding unit 440 calculates the difference of the area feature quantities. The area which is calculated the difference is shown by arrow which connects centers of each area.

The 440a in FIG. 4B indicated a manner which quantizes and encodes the calculated difference. In the 440a, when the difference which subtracts the second area feature quantity from the first area feature quantity in FIG. 4A is within a difference which is showed by dashed lines indicating the above-mentioned threshold value centered on the difference “0” (which is correspond to a case in which the average luminance is equal), the area feature quantity difference encoding unit 440 makes “0” the output value of quantum coding (frame feature quantity 450). When the difference is a positive (+) value which is a larger number than a position of the right side dashed line in the diagram, the area feature quantity difference encoding unit 440 makes “+1” the output value of quantum coding. When the difference is a negative (−) value which is a smaller number than a position of the left side dashed line in the diagram, the area feature quantity difference encoding unit 440 makes “−1” the output value of quantum coding. As above-mentioned manner, in the exemplary embodiment, the purpose of setting the code to multi-dimension such as three values having “−1”, “0” and “+1” is to make separation of the frame feature quantity become easy and to reduce calculation value of the comparison of the frame feature quantity. Therefore, the exemplary embodiment does not need to limit to the example of the above-mentioned three values. In addition, the threshold value showing by the dashed lines may be selected based on a ratio of the difference value which is quantized to “0” to the distribution of the difference value of all used dimension. As an example, the area feature quantity difference encoding unit 440 according to the exemplary embodiment selects the value which makes ratio of “0” to the quantized difference value become 50%.

The 450a in FIG. 4B illustrates an example of the frame feature quantity 450 which is gathered and created results of the quantum encoding of the difference. As a simple example, the frame feature quantity 450 is a lineup of values of quantum encoding of the differences in dimensional order in one-dimensional direction. In addition, the frame feature quantity 450 is not limited a lineup of the values of quantum encoding of the differences in dimensional order in one dimensional direction, may be lined up in multi-dimensional direction or be added additional calculation, and is not limited to the values shown in FIG. 4B.

FIG. 4C is the diagram showing the extraction area in the frame feature quantity extraction unit 230a-250a according to the exemplary embodiment.

In the 420a in FIG. 4B, a pair of areas of each dimension is showed by two rectangular areas. However, in order to calculate the frame feature quantity which appropriately expresses the frame, there is a case in that the shape other than the rectangle is desirable. And, there is a case in that one or both of the first extraction area and the second extraction area is not be a single area. The extraction areas shown in FIG. 4C are illustrating the first pair of areas and the second pair of areas including the extraction areas which are the rectangular area or not the rectangle area. The video processing device 210 according to the exemplary embodiment can set hundreds of dimensions, even when it realizes the matches of the frame feature quantity in real-time or the matches of a group of the frame feature quantity of the video content which is a set of the frame feature quantity based on ternary of each dimension as described in the 440a in FIG. 4B.

<<Hardware Configuration of Video Processing Device>>

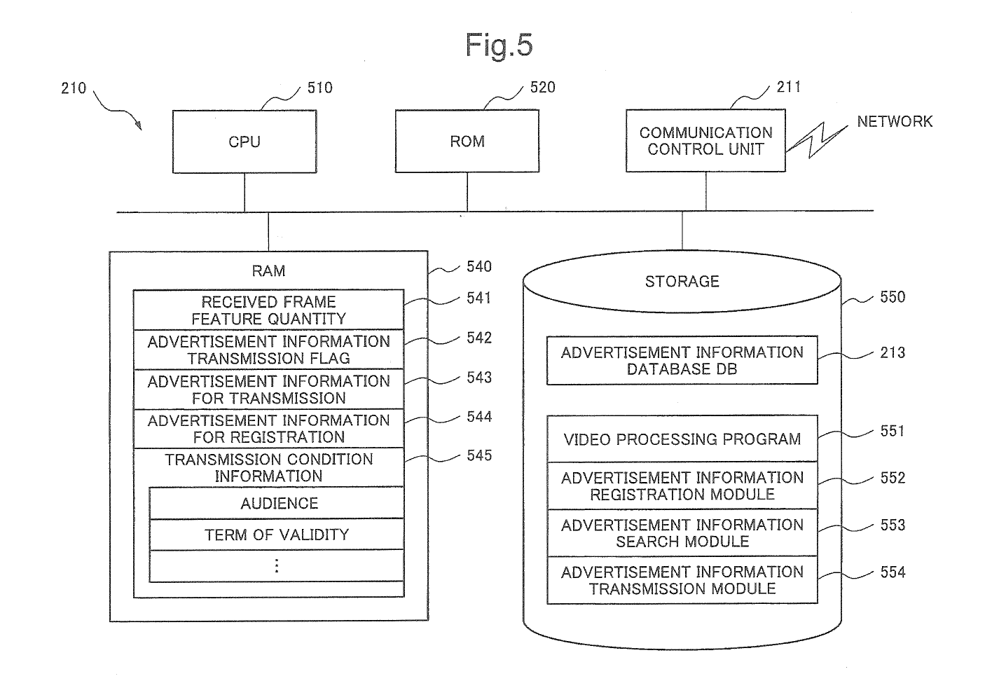

FIG. 5 is the block diagram showing the exemplary hardware configuration of the video processing device 210 according to the exemplary embodiment.

In FIG. 5, the video processing device 210 includes a CPU (Central Processing Unit) 510, a ROM (Read Only Memory) 520, a RAM (Random Access Memory) 540, a storage 550 and the communication control unit 211.

CPU 510 is a processor for controlling calculation and realizes functions of each functional configuration unit shown in FIG. 2 based on execution of program.

The ROM 520 stores fixed data such as initial data and a program.

The communication control unit 211 communicates with the video viewing terminals 230-250 or the video contents distribution server 260. In addition, the communication of the communication control unit 211 may be wireless communication or wired communication.

The RAM 540 is a memory which the CPU 510 uses as a work area of a temporary memory. In the RAM 540, an area in which the necessary data for realization of the exemplary embodiment is stored is secured. The necessary data, for example, includes such as the following data. A reception frame feature quantity 541 is a received reception frame feature quantity which is already converted into the frame feature quantity and received it from a destination. An advertisement information transmission flag 542 is a flag which is set when the reception frame feature quantity 541 is corresponding to the frame feature quantity of the advertisement information DB 213. Advertisement information for transmission 543 is advertisement information for transmission send to the video viewing terminal 230-250 of source which sends a frame feature quantity when the advertisement information transmission flag 542 is set. Advertisement information for registration 544 is advertisement information for registration for registering in the advertisement information DB 213. Transmission condition information 545 is information of transmission conditions which indicate the transmission conditions of the advertisement information and are optionally set. For example, the video viewing terminal 230-250 which transmits the advertisement information, audiences or periods (term of validity) for transmitting the advertisement information are set to the transmission condition information 545. In addition, needless to say, the transmission condition information 545 is not limited to these.

The storage 550 stores the advertisement information DB 213, the various parameters, the following modules and the programs required for realizing the exemplary embodiment. For example, the storage 550 stores following modules and programs. A video processing program 551 is a program for executing entire processes. An advertisement information registration module 552 is a module for registering the advertisement information in the video processing program 551. An advertisement information search module 553 is a module for searching advertisement information to be transmitted. An advertisement information transmission module 554 is a module for transmitting searched advertisement information.

In addition, FIG. 5 shows an example of data and programs according to the exemplary embodiment and omits illustration of common data and general programs such as an OS.

<Advertisement Information DB>

FIG. 6 is the diagram showing the exemplary configuration of the information in the advertisement information DB 213 according to the exemplary embodiment.

The advertisement information DB 213 is registered an advertisement information 602 (it corresponds to the advertisement information 110a in FIG. 1) associated with a frame feature quantity 601 (it corresponds to the frame feature quantity 120a in FIG. 1). In addition, as shown in FIG. 6, the frame feature quantities 601 may associate not only single but also the plural frame feature quantities 601 with the advertisement information 602. For example, the frame feature quantity 601 may register both the frame feature quantity of a certain frame and the frame feature quantity of a scene which is derived from the frame together. Based on this kind of the advertisement information DB 213, the video processing device 210 can transmit the advertisement information 602 for the derivation scene. In addition, in the exemplary embodiment, the transmission of the advertisement information 602 for the derivation scene can be realized by easing the match conditions of the frame feature quantity.

The advertisement information DB 213 may further store an option. The advertisement information DB 213 shown in FIG. 6 stores a transmission condition 603 as an example of the option. For example, the transmission condition 603 is an ID (Identifier) for audience which identifies the audience or a term of validity of the advertisement information 602. However, the option is not limited to these.

<<Process Procedure of Video Processing Device>>

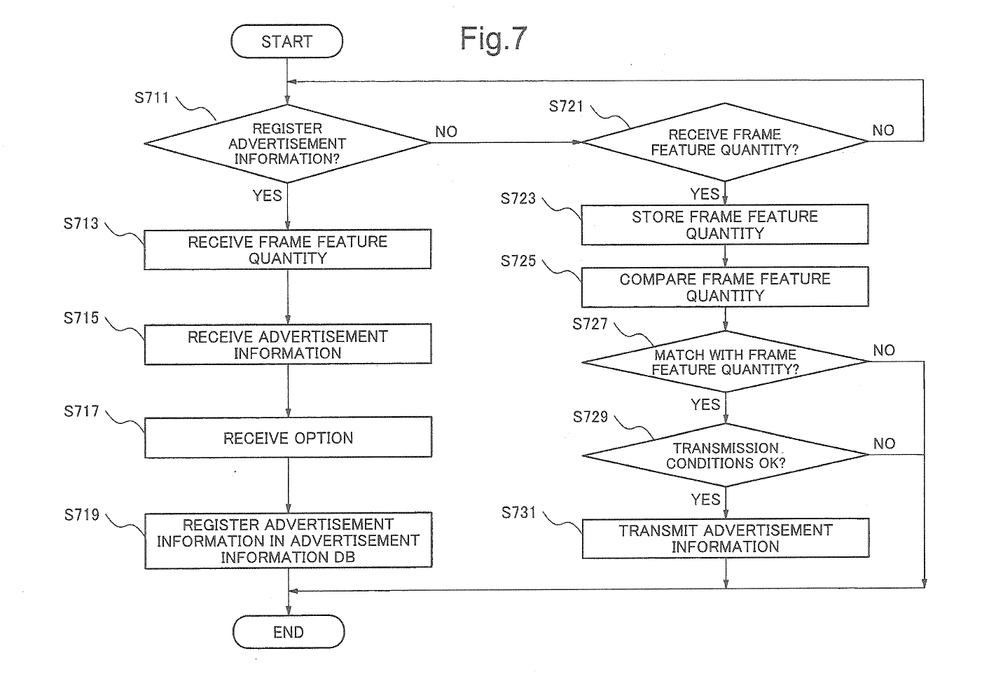

FIG. 7 is the flowchart showing the process procedure of the video processing device 210 according to the exemplary embodiment. The flowchart is, for example, the process procedure when the CPU 510 in FIG. 5 executes using the RAM 540 and realizes functions of each functional configuration unit shown in FIG. 2.

First, in Step S711, the video processing device 210 judges whether or not registration of the advertisement information 602 is instructed by the advertisement information input unit 220.

When the registration of the advertisement information 602 is instructed (YES in Step S711), the video processing device 210 advances towards Step S713, and executes the registration of the advertisement information 602.

When the registration of the advertisement information 602 is not instructed (NO in Step S711), the video processing device 210 advances towards Step S721, and judges whether or not it received the frame feature quantity 601 from the video viewing terminals 230-205.

When the video processing device 210 receives the frame feature quantity 601 (YES in Step S721), it advances towards Step S720, and executes transmission of the advertisement information 602.

When the video processing device 210 does not receive the frame feature quantity 601 (NO in Step S721), it returns to Step S711.

<Registration of Advertisement Information 602>

When registration of the advertisement information 602 is instructed (YES in Step S711), the video processing device 210 registers the advertisement information 602.

First, the video processing device 210 advances towards Step S713, and receives the frame feature quantity 601 from the advertisement information input unit 220.

Next, in Step S715, the video processing device 210 receives the advertisement information 602 which is associated with the frame feature quantity 601 and registered. In addition, as is described above, when the video processing device 210 provides a scene of video to the advertisement information input unit 220 and associates the scene with the advertisement information 602, the video processing device 210 does not need to execute Steps S713 and S715.

When using the option, in Step S717, the video processing device 210 receives the option (for example, the transmission condition 603). In addition, when the video processing device 210 does not use the option or receives it from other devices (for example, the video viewing terminal 230-250), this step is not necessary.

In Step S719, the video processing device 210 associates the advertisement information 602 received in Step S715 with the frame feature quantity 601, and registers it in the advertisement information DB 213.

<Transmission of Advertisement Information 602>

When the video processing device 210 receives the frame feature quantity 601 (YES in Step S721), it advances towards Step S723, and executes the transmission of the advertisement information 602.

First, in Step S723, the video processing device 210 stores the received frame feature quantity 601.

Next, in Step S725, the video processing device 210 compares the received frame feature quantity 601 with the frame feature quantity 601 in the advertisement information DB 213. In the comparison, for example, the video processing device 210 may store the received frame feature quantity 601 in a shift register, and sequentially compare it with the frame feature quantity 601 in the advertisement information DB 213 with shifting the shift register.

In Step S727, the video processing device 210 judges whether or not there is a matched frame feature quantity 601.

In the case of no match (NO in Step S727), the video processing device 210 finishes the process.

In the case of match (YES in Step S727), the video processing device 210 judges whether or not the transmission condition is satisfied in Step S729.

When the transmission condition is not satisfied (NO in Step S729), the video processing device 210 finishes the process.

When the frame feature quantity matches and the transmission condition is satisfied (YES in Step S729), the video processing device 210 transmits the advertisement information 602 to the video viewing terminal 230-250 of a transmission sources of the frame feature quantity in Step S731. Then, the video processing device 210 finishes the process.

The video processing system 200 and the video processing device 210 according to the second exemplary embodiment can provide (pay back) various types of the advertisement information 602 associated with a scene which an audience is viewing.

The reason is as follows. The video viewing terminal 230-250 of the video processing system 200 extracts the frame feature quantity 601 from a frame of the video being played back and send it to the video processing device 210. The video processing device 210 acquires the advertisement information 602 corresponding to the received frame feature quantity 601 from the advertisement information DB 213, and sends back it to the video viewing terminal 230-250. This is because, the video viewing terminals 230-250 notify (play back) the received advertisement information 602 by superimposing.

### Third Exemplary Embodiment

Next, the video processing system 200 according to the third exemplary embodiment of the present invention will be described. The video processing system 200 according to the exemplary embodiment is different in the point that it controls so as not to be able to play back (view) videos of continuation if the advertisement information 602 is output in the video viewing terminal 230-250 compared with the above-mentioned second exemplary embodiment. In addition, because other configurations and operations are similar to that of the second exemplary embodiment, the description other than the above-mentioned operation processes of the video processing system 200 is omitted.

The video processing system 200 according to the exemplary embodiment can control so that the audiences surely views the transmitted advertisement information 602 at the video viewing terminal 230-250. Accordingly, an advertiser who uses the video processing system 200 according to the exemplary embodiment can expect an effect of the advertisement furthermore.

<<Operation Process of Video Processing System>>

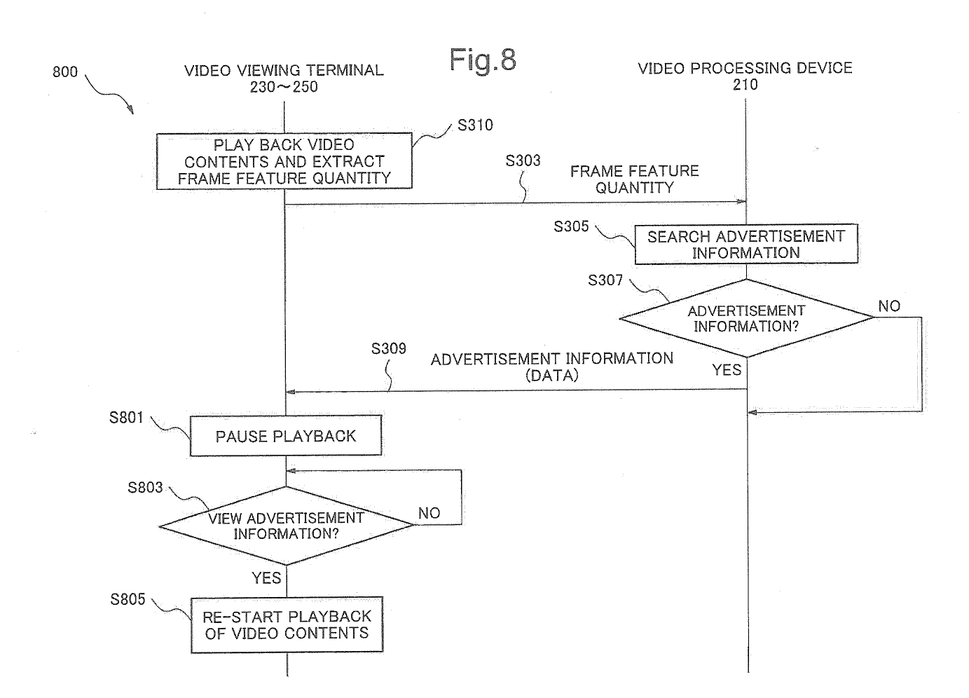

FIG. 8 is the sequence diagram showing the operation process 800 of the video processing system 200 according to the exemplary embodiment. In FIG. 8, because the sequences of S301 to S309 are similar to FIG. 3, the description is omitted.

The video viewing terminal 230-250 temporarily stops a playback of the video content (S801). Then, the video viewing terminal 230-250 notifies existence of the advertisement information 602 and that it resume playback if an audience views the advertisement information 602 to the audience. The notification may be any one of characters, sounds or images.

Then, the video viewing terminal 230-250 judges whether or not the audience views the advertisement information 602 (S803). The judgment of the video viewing terminal 230-250 is not limited. For example, the video viewing terminal 230-250 may detect a key operation of the audience. In addition, as the judgment of this, the video viewing terminal 230-250 may play back the advertisement information 602 based on a predetermined elapsed time since the notification.

When the video viewing terminal 230-250 judges that the audience does not view the advertisement information 602 (or does not play back the advertisement information 602) (NO in S803), it repeats the judgment until it judges to be viewed (played back).

When the video viewing terminal 230-250 judges that the audience views the advertisement information 602 (or plays back the advertisement information 602) (YES in S803), it advances towards Step S805 and resumes playback of the video contents.

In addition, in FIG. 8, the video viewing terminal 230-250 is illustrated so as executing a process after the stop of the playback by itself. However, in Step S309, the video viewing terminal 230-250 may download a program for confirming the viewing with the advertisement information 602, and execute it.

The video processing system 200 according to the third exemplary embodiment can obtain an effect that an audience surely views the advertisement information 602 transmitted to the video viewing terminal 230-250 in addition to the effect of the video processing system 200 according to the second exemplary embodiment.

The reason because the video viewing terminal 230-250 stops the playback of the video content until it can judge that the audience views the advertisement information 602.

### Fourth Exemplary Embodiment

Next, the video processing system 200 according to the fourth exemplary embodiment of the present invention will be described. The video processing system 200 according to the exemplary embodiment is different in the point that the advertisement information DB 213-2 stores an output program 1004 and an output target frame feature quantity 1005 in relation with the frame feature quantity 601 compared with the above-mentioned second exemplary embodiment. Moreover, it is different at the point that the video processing device 210 transmits the output program 1004 and the output target frame feature quantity 1005 of the advertisement information 602 in addition to the information of the advertisement itself to the video viewing terminal 230-250 as transmission of the advertisement information 602. Moreover, the video viewing terminal 230-250 is different at the point that it starts the received output program 1004. Then, the output program 1004 is a program which compares the output target frame feature quantity 1005 which the video processing device 210 transmits and the frame feature quantity 601 which appears in the video which is played back from now on, and outputs the advertisement information 602 at a time when the frame feature quantity 601 which matches with the output target frame feature quantity 1005 appears. In addition, because other configurations and operations of the video processing system 200 according to the exemplary embodiment are similar as the second exemplary embodiment, descriptions other than operation processes of the video processing system 200 and the advertisement information DB 213-2 according to the exemplary embodiment will be omitted. The video processing system 200 according to the exemplary embodiment can reduce a difference between a video and the advertisement information 602 being played back in the video viewing terminal 230-250, and output the advertisement information 602 according to timing in which it want to output.

<<Operation Process of Video Processing System>>

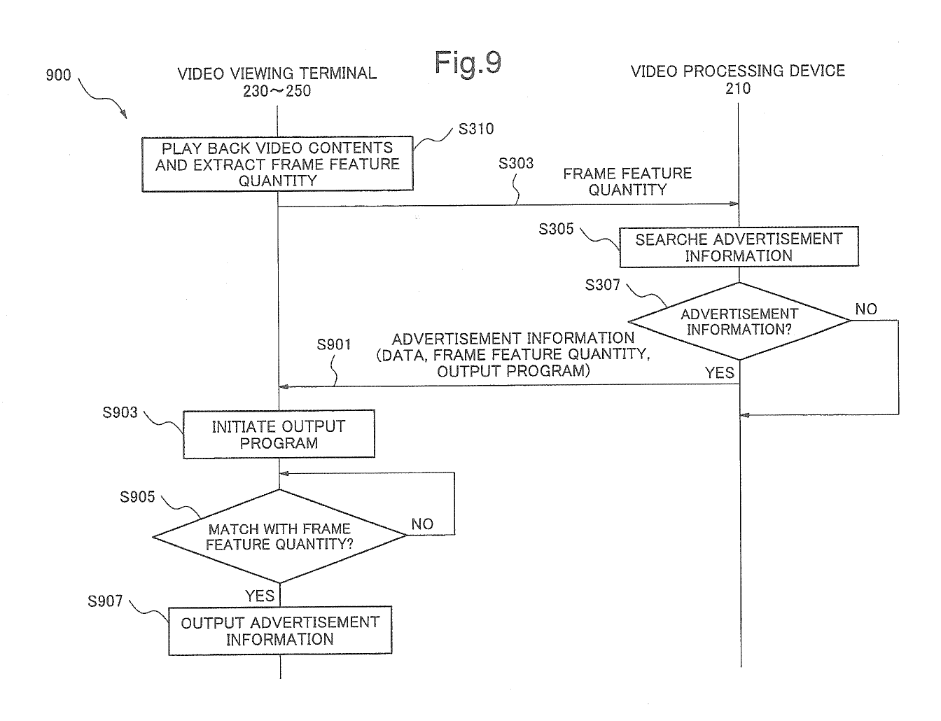

FIG. 9 is the sequence diagram showing the operation process 900 of the video processing system 200 according to the exemplary embodiment. In addition, because steps S301-S307 are similar to that of FIG. 3, the descriptions will be omitted.

The video processing device 210 transmits the output target frame feature quantity 1005 and the output program 1004 in addition to the data of the advertisement itself to the video viewing terminal 230-250 as the advertisement information 602, (S901).

The video viewing terminal 230-250 starts the output program 1004 (S903).

The output program 1004 judges whether or not the frame feature quantity 601 of a frame which the video viewing terminal 230-250 plays back matches with the output target frame feature quantity 1005. If matched, the output program 1004 advances towards Step S907, and outputs the advertisement information 602 (S905).

<Advertisement Information DB>

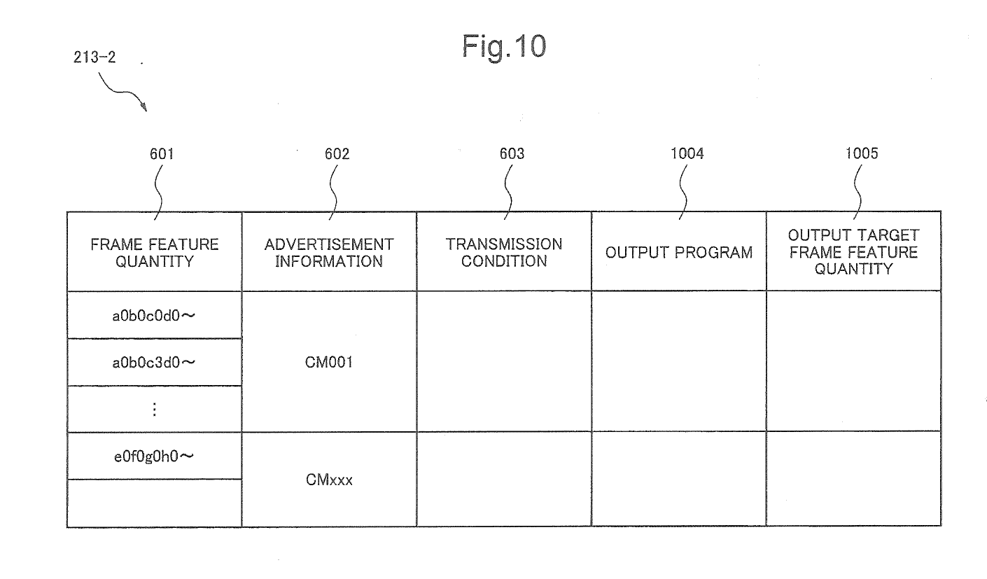

FIG. 10 is the diagram showing the exemplary configuration of an advertisement information DB 213-2 according to the exemplary embodiment.

As similar to FIG. 6, the advertisement information DB 213-2 stores the advertisement information 602 and the transmission condition 603 associated with the frame feature quantity 601. Further, the advertisement information DB 213-2 stores the output program 1004 and the output target frame feature quantity 1005.

The video processing system 200 according to the fourth exemplary embodiment can obtain an effect that it can reduce a difference between a video and the advertisement information 602 being played back in the video viewing terminal 230-250 in addition to the effect according to the second exemplary embodiment.

The reason is as follows. The video processing device 210 of the video processing system 200 according to the fourth exemplary embodiment transmits the output target frame feature quantity 1005 and the output program 1004 in addition to the data of the advertisement itself to the video viewing terminal 230-250. The video viewing terminal 230-250 starts the received output program 1004. This is because the output program 1004 judges whether or not the frame feature quantity 601 of a frame which the video viewing terminal 230-250 plays back and the received output target frame feature quantity 1005 are matches, and outputs the advertisement information 602 when they are matched.

### Fifth Exemplary Embodiment

Next, the video processing system 200 according to the fifth exemplary embodiment of the present invention will be described. When it compares with the advertisement information DB 213 according to the above-mentioned second exemplary embodiment, the advertisement information DB 213-3 of the video processing system 200 according to the exemplary embodiment is different at the point that the frame feature quantity 601 of matching target is grouped based on person who appeared in the video, compares with the advertisement information DB 213 according to the above-mentioned second exemplary embodiment. In addition, the video processing system 200 according to the fifth exemplary embodiment is different at the point that it outputs the advertisement information 602 when the person appears in the played back video. In addition, because other configurations and operations are similar to that of the second exemplary embodiment, other than descriptions on the advertisement information DB 213-3 will be omitted.

<Advertisement Information DB>

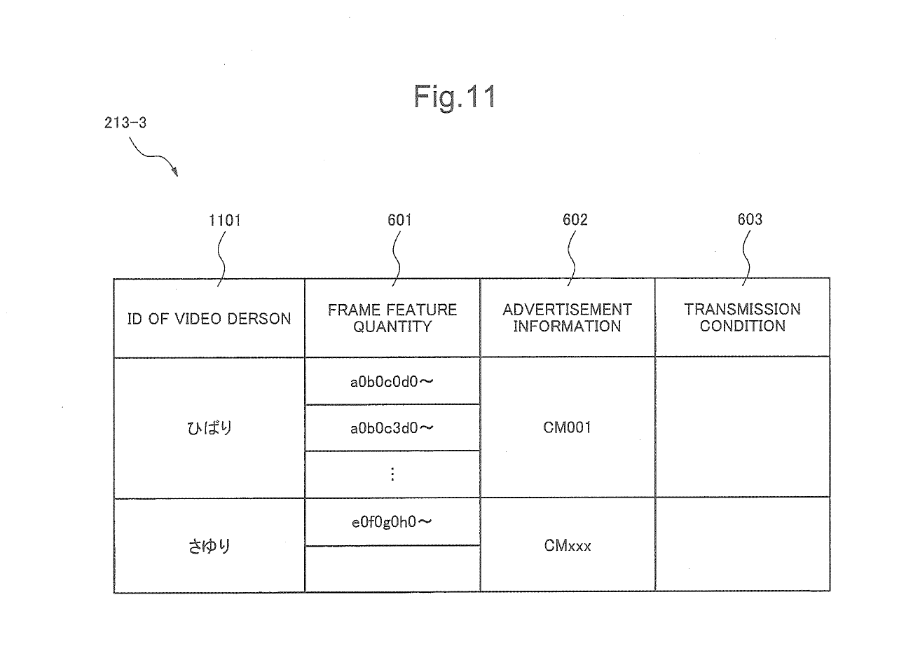

FIG. 11 is the diagram showing the exemplary configuration of the advertisement information DB 213-3 according to the exemplary embodiment.

The advertisement information DB 213-3 stores the frame feature quantity 601 of the scene which a person appears associated with an ID of video person 1101 of the person who appears in the video as a group. Then, the advertisement information DB 213-3 stores the advertisement information 602 and the optional transmission condition 603 which are transmitted if any one of the frame feature quantity 601 is matched.

In addition, though the exemplary embodiment is described using a person who appears in the video, it is not limited to this. For example, the advertisement information DB 213-3 may use a video of characteristic landscape for a travel advertisement or a video of specific buildings for an entertainment advertisement as information associated with the frame feature quantity 601. In this way, the exemplary embodiment can enlarge to various applications, and these enlargements are included in the exemplary embodiment.

The video processing system 200 according to the fifth exemplary embodiment can obtain an effect that it can outputs the advertisement information 602 when apparent person appears in a playback video in addition to the effect according to the second exemplary embodiment.

The reason is because the video processing system 200 according to the exemplary embodiment stores the frame feature quantity 601 associated with the ID of video person 1101.

### Other Exemplary Embodiment

The present invention may be applied to a system composed of plural devices or applied to a stand-alone device. Further, the present invention can be applied to a case in which a control program which realizes the functions of the exemplary embodiments is directly or remotely provided to the system or the device. Accordingly, in order to realize the functions of the present invention by a computer, a control program installed in the computer, media which stores the control program and WWW (the World Wide Web) server which makes the control programs be downloaded are included in the scope of the present invention.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2011-139338, filed on Jun. 23, 2011, the disclosure of which is incorporated herein in its entirety by reference.

### DESCRIPTION OF CODES

100 Video processing system

110 Advertisement information database

110a Advertisement information

120 Frame feature quantity extraction unit

120a Frame feature quantity

130 Advertisement information acquisition unit

200 Video processing system

210 Video processing device

211 Communication control unit

212 Frame feature quantity storage unit

213 Advertisement information database

213-2 Advertisement information database

213-3 Advertisement information database

214 Advertisement information search unit

215 Advertisement information registration unit

216 Advertisement information transmission unit

220 Advertisement information input unit

230 Video viewing terminal

230a Frame feature quantity extraction unit

240 Video viewing terminal

240a Frame feature quantity extraction unit

250 Video viewing terminal

250a Frame feature quantity extraction unit

260 Video contents distribution server

270 Network

300 Operation process

410 Dimension decision unit

420 Extraction area acquisition unit

430 Area feature quantity calculation unit

431 First area feature quantity calculation unit

432 Second area feature quantity calculation unit

440 Area feature quantity difference encoding unit

450 Frame feature quantity

510 CPU

520 ROM

540 RAM

541 Reception frame feature quantity

542 Advertisement information transmission flag

543 Advertisement information for transmission

544 Advertisement information for registration

545 Transmission condition information

550 Storage

551 Video processing program

552 Advertisement information registration module

553 Advertisement information search module

554 Advertisement information transmission module

601 Frame feature quantity

602 Advertisement information

603 Transmission condition

800 Operation process

900 Operation process

1004 Output program

1005 Output target frame feature quantity

1101 ID of video person

1. A video processing system, comprising:
an advertisement information database which stores advertisement information associated with a frame feature quantity which characterizes a frame included in a video, and enabling to search the advertisement information which is corresponding to the frame feature quantity;
a frame feature quantity extraction unit which extracts the frame feature quantity from a frame of video being played back; and
an advertisement information acquisition unit which acquires the advertisement information corresponds to the frame feature quantity which is extracted by said frame feature quantity extraction unit from said advertisement information database.

2. The video processing system according to claim 1, comprising:
an advertisement information registration unit which registers the advertisement information which is associated with the frame feature quantity in said advertisement information database.

3. The video processing system according to claim 1, comprising:
an advertisement information transmission unit which transmits the advertisement information which is acquired by said advertisement information acquisition unit to a video playback device which is viewing a video.

4. The video processing system according to claim 1, wherein
said advertisement information database stores the advertisement information associated with the frame feature quantity of plural frames.

5. The video processing system according to claim 4, wherein
said advertisement information database stores the advertisement information associated with plural frame feature quantities including a derivation scene which is derived from a certain scene.

6. The video processing system according to claims 2, wherein
said advertisement information registration unit registers the advertisement information in said advertisement information database so that it is associated with the frame feature quantity and an audience, and
said advertisement information database searches the advertisement information according to the frame feature quantity and the audience.

7. The video processing system according to claim 2, wherein
said advertisement information registration unit sets a period for transmitting the advertisement information, and
said advertisement information transmission unit transmits the advertisement information in the period.

8. The video processing system according to claim 1, wherein
the advertisement information includes a data and a program for controlling output of the data.

9. The video processing system according to claim 1, wherein
said frame feature quantity extraction unit is included in a video playback device which plays back the video, and
said advertisement information database and said advertisement information acquisition unit are included in a video processing device which is connected with said video playback device via a network.

10. The video processing system according to claim 1, wherein
said frame feature quantity extraction unit combines differences of area feature quantities which are calculated to each pair of areas for plural pairs of areas which are set to each frame, and make it the frame feature quantity.

11. The video processing system according to claim 10, wherein
the area feature quantity is expressed with luminance.

12. The video processing system according to claim 1, wherein
the advertisement information includes information including at least one of a video, a sound and a letter.

13. An advertisement acquisition method, comprising:
extracting a frame feature quantity from a frame of a video being played back;
storing advertisement information associated with the frame feature quantity which characterizes the frame included in the video corresponding to the frame feature quantity which is extracted; and
acquiring the advertisement information from an advertisement information database which can search the advertisement information corresponding to the frame feature quantity.

14. A video processing device, comprising:
an advertisement information database which stores advertisement information associated with a frame feature quantity which characterizes a frame included in a video and enabling to search the advertisement information which is corresponding to the frame feature quantity;
a frame feature quantity reception unit which receives the frame feature quantity extracted from the frame of the video being played back; and
an advertisement information acquisition unit which acquires the advertisement information from said advertisement information database corresponding to the frame feature quantity which is received by said frame feature quantity unit.

15. The video processing device according to claim 14, comprising:
an advertisement information registration unit which registers the advertisement information associated with the frame feature quantity in said advertisement information database.

16. The video processing device according to claim 14, comprising:
an advertisement information transmission unit which transmits the advertisement information which is acquired by said advertisement information acquisition unit to a video playback device which is playing back the video.

17. A method of controlling a video processing device, comprising:
receiving a frame feature quantity extracted from a frame of a video being played back;
storing advertisement information associated with the frame feature quantity which characterizes the frame included in the video corresponding to the received frame feature quantity; and
acquiring the advertisement information from an advertisement information database which can search the advertisement information corresponding to the frame feature quantity.

18. A computer readable medium embodying a program, said program causing a video processing device to perform a method, said method comprising:
receiving a frame feature quantity extracted from a frame of a video being played back; and
storing advertisement information associated with the frame feature quantity which characterizes the frame included in the video corresponding to the frame feature quantity which is received in the frame feature quantity reception process; and
acquiring the advertisement information from an advertisement information database which can search the advertisement information corresponding to the frame feature quantity.

19. A video processing system, comprising:
an advertisement information database for storing advertisement information associated with a frame feature quantity which characterizes a frame included in a video, and enabling to search the advertisement information which is corresponding to the frame feature quantity;
frame feature quantity extraction means for extracting the frame feature quantity from a frame of video being played back; and
advertisement information acquisition means for the advertisement information corresponds to the frame feature quantity which is extracted by said frame feature quantity extraction means from said advertisement information database.
